(19) United States
(12) Patent Application Publication
(10) Pub. No.: US 2025/0384020 A1
(43) Pub. Date: Dec. 18, 2025

(54) SYSTEM AND METHOD FOR JSON DATA PROCESSING

(71) Applicant: State Farm Mutual Automobile Insurance Company, Bloomington, IL (US)

(72) Inventor: Alexander GATARIC, Normal, IL (US)

(73) Assignee: State Farm Mutual Automobile Insurance Company, Bloomington, IL (US)

(21) Appl. No.: 18/810,892

(22) Filed: Aug. 21, 2024

Related U.S. Application Data
(60) Provisional application No. 63/658,958, filed on Jun. 12, 2024.

(51) Int. Cl. G06F 16/22; G06F 16/21; G06F 16/23; G06F 16/25

(52) U.S. Cl. CPC G06F 16/2237; G06F 16/213; G06F 16/2365; G06F 16/258

(57) ABSTRACT

Systems and methods for deriving array subscripts from nested ranges in a JSON structure are disclosed. The method may include, such as by one or more processors: (1) loading and parsing JSON data to convert a JSON string of the JSON data into a data structure, wherein the JSON data includes objects, arrays, and/or primitive values; (2) traversing the data structure to identify nested ranges within the objects, arrays, and/or primitive values; (3) storing start and end positions of the nested ranges; (4) extracting element ranges by dissecting the nested ranges, including array ranges, into individual array element ranges based upon position information; (5) mapping array indices to the corresponding individual array element ranges by correlating an element of the arrays to individual array element ranges; and/or (6) sending queries to a database, the queries include at least one of the array indices and the correlated at least one element.

### CROSS-REFERENCE TO RELATED APPLICATION

This patent application claims the benefit of priority to U.S. Provisional Application 63/658,958, filed on Jun. 12, 2024, the entirety of which is incorporated herein by reference.

### TECHNICAL FIELD

This present disclosure relates generally to the field of data processing. In particular, the present disclosure relates to JSON data processing and analysis.

### BACKGROUND

JavaScript Object Notation (JSON) is a data format that may contain multiple nested data structures of objects, arrays, and primitive key-value pairs in what is called a path (the objects, arrays, and primitive key-value pairs may be referred hereinafter as “elements,” a commonly used terminology to generically describe all JSON objects when parsing the data structure using programmatic methods). However, determining a particular object or array that contains a specific primitive key-value may present a challenge due to the hierarchical nature of the data. The hierarchal data structure may resemble parent-child table relationships in a relational data model.

A path is a traversal route needed to access a specific element(s). Current methods may rely on JSON parsing functions, which may include a manually coded top-down traversal using programmatic methods through each path, iteratively parsing elements until the desired primitive key-value(s) is located. This may be inefficient as traversing the entire path may not offer a direct mechanism to access deeply nested data elements without exhaustive coding and traversal of each path. This process may resemble traversing a relational data model starting from the highest parent table to the child table with desired columns. In JSON, nested array unnesting may involve handling sequences of related data items, while nested objects unnesting may involve hierarchical structures of key-value pairs. Nested array unnesting may require precise indexing to access specific elements, whereas nested object unnesting may involve managing hierarchical key-value pairs. These differences may pose challenges in querying and manipulating nested JSON structures, as each type may demand distinct handling methods.

In the JSON data format, particularly within a specific type or category, individual documents may contain data elements that may not be uniformly presented across all documents of that type. This variability may pose a challenge in accurately determining the available elements within the JSON structure, often resulting in suboptimal utilization of the JSON data format. Traditionally, users may rely on requesting the data model from the JSON creator to discern the structure, however, in cases where the data model is unavailable or inaccessible, this approach may become impractical.

The current method of extracting data from JSON files through programmatic JSON parsing functions may rely on a top-down parsing approach, which may pose technical limitations in efficiently resolving data extraction challenges. This method may require traversing the entire path, which may lead to increased computation overhead and processing time. Moreover, this approach may lack the flexibility to selectively extract targeted data subsets, as it may mandate parsing the entire JSON document, regardless of the data elements needed. This approach may fail to provide an optimized solution for streamlined data extraction, particularly when dealing with large or complex JSON datasets where selective retrieval may be paramount for performance and resource efficiency.

### SUMMARY

The present embodiments may relate, inter alia, to solving one or more technical challenges, such as those discussed above and elsewhere herein. Specifically, the present computer systems and computer-implemented methods may solve technical challenges by (i) implementing nested ranges for streamlining data extraction and facilitating targeted access to specific elements, where each parent element may be assigned a range that may encompass all its child elements and this process may continue until all elements, down to the primitive key-value pairs, are assigned to appropriate ranges; (ii) generating a relational structure and element within each element or array type through sets of ranges to determine element nesting and associated elements; and/or (iii) implementing range-based matching and extraction for handing nested structures.

In one aspect, a computer-implemented method for deriving array subscripts from nested ranges in a JSON structure may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) loading and parsing JSON data to convert a JSON string of the JSON data into a data structure, wherein the JSON data includes one or more objects, one or more arrays, and/or one or more primitive values; (2) traversing the data structure to identify one or more nested ranges within the one or more objects, the one or more arrays, and the one or more primitive values; (3) storing a start position and an end position of the one or more nested ranges; (4) extracting one or more element ranges by dissecting the one or more nested ranges including one or more array ranges into one or more individual array element ranges based upon position information; (5) mapping one or more array indices to the corresponding one or more individual array element ranges, wherein the mapping includes correlating at least one element of the one or more arrays to the one or more individual array element ranges; and/or (6) sending one or more queries to a database, wherein the one or more queries include at least one of the one or more array indices and the correlated at least one element. The method may include additional, less, or alternate functionality, including that discussed elsewhere herein.

In another aspect, a computer-implemented method for generating a relational structure from a JSON data structure may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) loading and parsing JSON data to convert a JSON string into a hierarchical data structure, wherein the JSON data includes one or more data elements; (2) traversing the JSON structure to identify one or more ranges, which include a start position and an end position, of the one or more data elements including one or more objects, one or more arrays, and one or more primitive values; (3) organizing the identified one or more ranges hierarchically to reflect a nested structure of the JSON data; (4) mapping the one or more hierarchical identified nested ranges to a relational schema, wherein the mapping includes defining one or more relational tables and one or more corresponding relational table relationships based upon the identified ranges; and/or (5) storing and utilizing the mapped hierarchical identified nested ranges and the relational schema for querying, retrieval, and/or manipulation of the one or more data elements based upon the corresponding mapped hierarchical identified nested ranges. The method may include additional, less, or alternate functionality, including that discussed elsewhere herein.

In yet another aspect, a computer-implemented method for automating a conversion of JSON data to one or more relational tables may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) loading and parsing the JSON data to convert a JSON string into a hierarchical data structure, wherein the JSON data includes one or more data elements; (2) generating a relational schema by aggregating one or more columns based on one or more hierarchical layers identified within the hierarchical data structure; (3) generating one or more create table statements for creating the one or more relational tables based on the relational schema, wherein the relational schema of each of the one or more relational tables includes one or more data types and one or more structures derived from the JSON data; (4) extracting one or more primitive values from one or more JSON elements within the hierarchical data structure; (5) aggregating the one or more primitive values to generate one or more insert statements matching the relational schema of the one or more relational table; (6) executing the one or more insert statements to insert one or more rows into the one or more relational tables; and (7) verifying an accuracy of the one or more rows inserted into the one or more relational tables by cross-referencing the one or more rows with JSON data.

In yet another aspect, a computer-implemented method for extracting data from a JSON structure using range of rows may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) loading and formatting JSON data to determine the JSON data is structured and indented, wherein the JSON data includes one or more data elements; (2) traversing the JSON data to identify one or more ranges, which include a start position and an end position, of the one or more data elements that include one or more static elements and/or one or more array elements; (3) organizing the identified one or more ranges hierarchically to reflect a nested structure of the JSON data; (4) accessing the one or more elements using one or more sets of ranges, wherein the accessing includes locating and extracting one or more specific elements within the JSON; and/or (5) utilizing one or more functions for querying and manipulating the JSON data based upon the one or more specific elements. The method may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary architecture diagram for JSON data processing, according to certain aspects of the disclosure.

FIG. 2 is an exemplary flowchart of a computer-implemented or computer-based process for deriving array subscripts from nested ranges in a JSON structure, according to one or more embodiments.

FIG. 3A is an exemplary flowchart of a computer-implemented or computer-based process for generating a relational structure from a JSON data structure, according to one or more embodiments.

FIG. 3B is an exemplary flowchart of a computer-implemented or computer-based process for dynamically generating create table statements and/or insert statements to automate the conversion of JSON data to relational tables, according to one or more embodiments.

FIG. 4 is an exemplary flowchart of a computer-implemented or computer-based process for extracting data from a JSON structure using a range of rows, according to one or more embodiments.

FIG. 5 illustrates an implementation of an exemplary computer system that executes techniques presented herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may solve technical challenges by (i) implementing nested ranges for streamlining data extraction and facilitating targeted access to specific elements; (ii) generating a relational structure and element within each element or array type through sets of ranges to determine element nesting and associated elements; and/or (iii) implementing range-based matching and extraction for handing nested structures.

JavaScript Object Notation (JSON) is a lightweight data interchange format that has become ubiquitous in modern software development. Its simplicity, readability, and flexibility make it an ideal choice for transmitting and storing structured data across diverse platforms and systems. JSON's key-value pair structure and support for nested objects and arrays enable the representation of complex data hierarchies in a concise format. However, despite its numerous advantages, JSON is not without technical drawbacks.

JSON may contain multiple levels of nested arrays, making it challenging to pinpoint the exact array in which a specific value resides. This complexity may arise from the hierarchical structure of JSON, where arrays can be embedded within other arrays or objects, creating deeply nested data. Typically, to locate a particular value within such a structure, JSON parsing functions are used, which may necessitate a path-based approach. This may mean starting searching from the root of the JSON document and progressively traversing through each level of the hierarchy, unnesting arrays as encountered, until the target value is found. This process may be computationally intensive and cumbersome, particularly for large and deeply nested JSON documents, leading to inefficiencies in data extraction and manipulation.

In the JSON data format (“JSON data”), elements may vary between different instances of the same JSON type, posing challenges in determining the available elements within the structure and leading to the inefficient utilization of the JSON format. This variability may complicate the identification of elements present in a specific JSON document, often necessitating users to consult the JSON creator for the data model to ascertain the structure. As a result, the absence of consistent elements across JSON instances may hamper seamless data processing and interoperability, highlighting the importance of establishing standardized data models to enhance the usability and understanding of JSON structures.

JSON files may often necessitate the use of programmatic JSON parsing functions to extract data, a process that typically involves parsing the data from the top-down. While this approach may enable the extraction of related data within the structure, it may also impose a sequential parsing methodology, requiring multiple steps to navigate through the JSON hierarchy. As a result, accessing specific data elements within the JSON file may entail traversing the path, which may be time-consuming and resource-intensive, particularly in cases where only certain portions of the data are required for analysis or processing. These technical shortcomings underscore the need for innovative solutions to enhance JSON data management and processing workflows, ensuring its continued relevance and effectiveness in modern software development practices.

### Exemplary System Architecture for JSON Data Processing

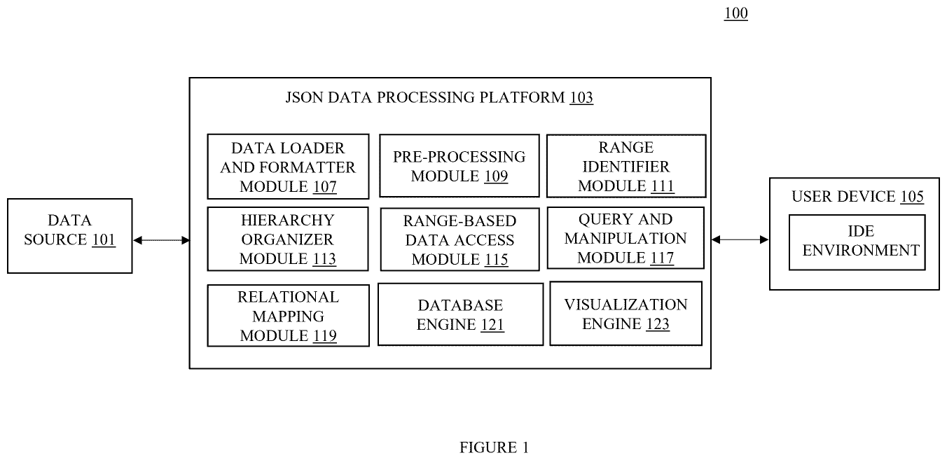

To address technical challenges, such as the above, system 100 of FIG. 1 may generate a relational structure from JSON data using nested ranges, where such a concept may impose an implicit schema on the data. This relational mapping may allow for consistent data validation and integrity checks, ensuring uniformity and reducing errors in data interpretation. Instead of relying on traditional path JSON parsing functions, the system 100 may utilize sets of ranges to determine element nesting and directly access specific elements. This method may bypass the need for sequential traversal, significantly reducing computational overhead and enabling faster data retrieval, especially in deeply nested structures.

Further, the system 100 may facilitate the hierarchical organization of ranges that accurately reflect the nested relationships within the JSON data. This organization may facilitate the efficient extraction and manipulation of data subsets, by allowing users to identify and work with specific elements without parsing the entire document, thereby improving performance and resource efficiency. The system 100 may map the JSON data to a relational schema to ensure that all elements are accounted for and properly structured. This relational approach may enforce a consistent data model, which may maintain data integrity across different JSON documents and versions. The system 100 may implement functions for querying and manipulating data based upon derived ranges, thus allowing for precise and efficient updates. This approach may ensure that modifications are localized and do not require re-parsing the entire JSON document, thereby enhancing both performance and accuracy in data handling.

FIG. 1 depicts a diagram showing an exemplary architecture diagram for JSON data processing, according to certain aspects of the disclosure. FIG. 1 includes a data source 101, a JSON data processing platform 103, and/or a user device 105. It should be understood that other implementations of system 100 may omit one or more of the foregoing components and/or may include additional components, as the case may be.

In one instance, data source 101 may encompass a diverse range of repositories, including JSON files, APIs, databases, and/or other data storage mechanisms for providing JSON data for processing and analysis. In one example, the data source 101 may include structured databases (e.g., MySQL), where JSON documents may be stored as collections or tables. In one example, JSON data may be sourced from web applications, IoT devices, or external data providers that provide data in JSON format. In another example, the data source 101 may include real-time data streams and/or dynamic data sources for continuous ingestion and processing of JSON data, supporting applications such as real-time analytics, monitoring, and event-driven architectures. Such flexibility of the data source may allow for the seamless integration with different systems and data formats, ensuring accessibility and versatility in data processing workflows.

In one aspect, the JSON data processing platform 103 may include a platform with multiple interconnected components, and may include one or more servers, intelligent networking devices, computing devices, components, and corresponding software. In one instance, the JSON data processing platform 103 may utilize nested ranges to efficiently determine the array elements associated with each element, without necessitating prior knowledge of the JSON structure or the need for top-down unnesting. This may involve establishing a hierarchical structure of ranges that may represent the nesting of elements within the JSON data.

For instance, each range may correspond to a specific array, nested array(s), or nested object(s) within the JSON structure. By defining ranges for both objects and arrays, the method may ensure a comprehensive mapping of the entire JSON structure, enabling precise identification and extraction of elements regardless of their type or nesting level. By associating each element within the range(s) that encapsulate the element, the array to which the element belongs may be efficiently determined. This may facilitate precise and targeted data extraction, allowing for more efficient analysis and manipulation of JSON data.

In one instance, the JSON data processing platform 103 may generate a relational structure of the JSON data by identifying and organizing the elements within each object or array type. By utilizing sets of nested ranges, the JSON data processing platform 103 may determine the hierarchical relationships and nesting levels of elements within the JSON structure. Each range may correspond to specific segments of the JSON data, capturing the hierarchical positioning of elements. Accordingly, the JSON data processing platform 103 may map out the structure and associate each element with its respective array or object, providing a clear and efficient way to understand and manipulate the JSON data without requiring traditional top-down parsing.

In various embodiments, the JSON data processing platform 103 may utilize a range-based matching to process JSON data, bypassing traditional JSON parsing functions. By utilizing ranges of rows within a formatted JSON structure, the JSON data processing platform 103 may efficiently identify both static elements and array elements. In one example, a static element may be a single key-value pair in a JSON object, such as “name”: “Ray Smith” or “age”: 40. In one example, an array element may be a part of an array, such as {“type”: “home”, “number: “555-1234”} within the phone numbers array.

Additionally, the JSON data processing platform 103 may identify a single array element and the extraction of all related elements within that array, without the need to parse the entire JSON path. For example, by using predefined ranges that map the structure of the JSON data, the JSON data processing platform 103 may directly locate an individual array element based upon its range. The predefined ranges may refer to the specific start and end positions assigned to elements within the JSON structure. In one example, if a JSON array starts at position 50 and ends at position 200, each element within this array would have its own predefined range within this segment, allowing the system to directly access any individual element based upon its positional range. Once the target element is identified, all other elements within the same range, which belong to the same array, may be efficiently extracted together. This may eliminate the need for a full hierarchical traversal, and may allow for quick, targeted access to the desired data, resulting in significantly improving the efficiency of data processing.

In one instance, the JSON data processing platform 103 may comprise a data loader and formatter module 107, a pre-processing module 109, a range identifier module 111, a hierarchy organizer module 113, a range-based data access module 115, a query and manipulation module 117, a relational mapping module 119, a database engine 121, and a visualization engine 123, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In certain instances, the data loader and formatter module 107 may ingest and prepare JSON data for subsequent processing. In one instance, the data loader and formatter module 107 may load JSON files from various sources (e.g., data source 101), ensuring compatibility with different input formats. Once the JSON data is loaded, the data loader and formatter module 107 may perform a series of formatting tasks to standardize the data structure. This process may include normalizing JSON keys, handling missing or null values, and converting data types to ensure consistency across the dataset. Additionally, the data loader and formatter module 107 may identify and tag static and array elements, preparing them for range-based matching and extraction. By organizing the data into a coherent, formatted structure, the data loader and formatter module 107 may facilitate a seamless integration with other system components, thus optimizing the overall data processing workflow.

In one instance, the pre-processing module 109 may refine and enhance JSON data before it undergoes further analysis and transformation. Additionally or alternatively, the pre-processing module 109 may cleanse and validate the JSON data to ensure its integrity and reliability. This may involve detecting and correcting inconsistencies, such as duplicated entries, erroneous data points, and format discrepancies. The pre-processing module 109 may handle a schema inference, where the pre-processing module 109 may analyze the JSON data structure to deduce an implicit schema, resulting in identifying the hierarchical relationships between different elements. Additionally, the pre-processing module 109 may perform data enrichment by augmenting the JSON data with supplementary information, which may be derived from external sources or calculated based upon existing data. By segmenting JSON data into manageable ranges, the pre-processing module 109 may organize the data into a format suitable for efficient range-based processing.

In certain embodiments, the range identifier module 111 may transform the JSON data into a structured format by delineating the hierarchical boundaries within the dataset. The range identifier module 111 may analyze the JSON structure and assign specific ranges to different elements, effectively mapping out the nested relationships. This may involve identifying the start and end points of arrays and objects within the JSON documents and categorizing them into hierarchical levels. By doing so, the range identifier module 111 may create a clear and precise representation of the data's structure, thereby enabling efficient data access and manipulation. The range identifier module 111 may also tag static and dynamic elements, which may result in distinguishing between single-value elements and those that are part of arrays. Such tagging may facilitate targeted data extraction, allowing for the quick identification of related elements within the same range. Additionally, the range identifier module 111 may support dynamic adjustments, so that changes in the JSON structures may be promptly reflected in the range mapping.

In one instance, the hierarchy organizer module 113 may establish a clear and navigable relational structure within JSON data by systematically arranging elements according to their nested relationships. The hierarchy organizer module 113 may take the ranges identified by the range identifier module 111, and may then organize them into a coherent hierarchy, ensuring that each element is accurately positioned within the broader structure. The hierarchy organizer module 113 may assign parent-child relationships, creating a relational model that may mirror the original JSON nested format. By doing so, the hierarchy organizer module 113 may facilitate efficient traversal and querying of the data. Additionally, the hierarchy organizer module 113 may handle edge cases, such as deeply nested arrays and complex object structures, to maintain a consistent organizational scheme. Such a structured representation may allow for the precise extraction, manipulation, and analysis of the JSON data.

In certain instances, the range-based data access module 115 may leverage pre-defined ranges for efficient data retrieval and manipulation within the JSON structure. The range-based data access module 115 may utilize the hierarchical and relational mappings, which may have been established by the previous modules, to facilitate direct access to specific elements and their associated data without requiring a full traversal of the JSON document.

In one instance, the range-based data access module 115 may index the JSON data into easily addressable segments, allowing for rapid lookups and modifications. Such a feature is beneficial for deeply nested elements or performing batch operations on array elements. The range-based data access module 115 may support advanced querying techniques to enable complex data filters that may be typically challenging in a purely hierarchical JSON context. By providing a streamlined interface for data access, the range-based data access module 115 may reduce the computational overhead and latency associated with traditional parsing methods.

In various embodiments, the query and manipulation module 117 may build on the structured and indexed data provided by the preceding modules. The query and manipulation module 117 may also facilitate precise querying by applying filters, sorting, and aggregation directly on the structured JSON data, and by utilizing range-based indexing for swift retrieval. The query and manipulation module 117 may facilitate data manipulation tasks such as inserting, updating, and deleting elements within the JSON structure. These operations may be optimized through the use of range-based indexing, allowing for efficient and targeted modification without the need for exhaustive parsing. The query and manipulation module 117 may ensure transactional integrity by maintaining data consistency and reliability during concurrent operations. In one instance, certain databases, such as PostgreSQL, may feature a native range data type, operators, functions, and indexing capabilities, which may significantly enhance the efficiency of querying ranges. This functionality may allow for the rapid retrieval of data within specified intervals, optimizing performance and reducing query execution time for range-based operation.

In one instance, the relational mapping module 119 may transform the hierarchical JSON data into a structured relational format. The relational mapping module 119 may map each JSON element, including nested arrays and objects, into a schema similar to a relational database. The relational mapping module 119 may establish primary and foreign key relationships among the elements, ensuring that hierarchical dependencies are accurately represented. By converting the JSON structure into tables with defined relationships, the relational mapping module 119 may facilitate the efficient querying and data manipulation using relational database principles. The relational mapping module 119 may handle the complexities of varying JSON schemas by dynamically adjusting the relational mappings to accommodate different data structures. This may ensure a consistent and reliable framework for data access, supporting complex joins and aggregations.

In one instance, the database engine 121 may store, retrieve, and manage structured data within the JSON processing system. The database engine 121 may facilitate efficient data storage by employing compression techniques and adaptive storage strategies that accommodate the dynamic nature of JSON data. For example, the database engine 121 may seamlessly integrate relational mappings created by other modules for high-performance data processing. The database engine 121 may provide robust and efficient mechanisms for handling large volumes of data. The database engine 121 may be optimized for executing complex queries and data operation, leveraging indexing and caching strategies to ensure rapid data access and manipulation.

In various instances, the visualization engine 123 may convert JSON data to facilitate data interpretation and analysis. In one example, by utilizing the relational structure generated by the processing modules, the visualization engine 123 may create dynamic and interactive visualizations such as charts, graphs, and/or dashboards. The visualization engine 123 may support a range of visualization types to cater to diverse analytical needs, including bar charts, line graphs, pie charts, scatter plots, and heat maps. The visualization engine 123 may integrate seamlessly with the data querying mechanisms to allow real-time updates and explorations of data trends and patterns. The visualization engine 123 may employ rendering optimizations to ensure smooth performance, even with large and complex datasets. By providing intuitive and customizable visual output, the visualization engine 123 may enhance the user's ability to understand and derive insights from the JSON data.

In one instance, the user device 105 running an integrated development environment (IDE) for JSON data processing may include desktop computers, laptops, tablets, and/or smartphones. These devices typically feature robust hardware specifications, including multi-core processors, substantial RAM, and high-resolution displays to efficiently handle the demands of data-intensive tasks and complex JSON structures. The IDE environment on these devices may provide a comprehensive suite of tools for coding, debugging, and/or visualizing JSON data to support features such as syntax highlighting, auto-completion, and integrated version control. In one example, desktop and laptop environments, such as those running on Windows, macOS, or Linux, may offer a powerful and flexible platform, facilitating seamless multitasking and integration with external databases and/or services. In one example, tablets and smartphones may benefit from touch interfaces and portability, allowing for on-the-go coding and data analysis. Regardless of the device type, the IDE environment facilitates efficient JSON data processing.

In certain embodiments, the JSON data processing platform 103 and its components (e.g., module 107-123) may be seamlessly integrated into the user device 105. Each module of the JSON data processing platform 103 may operate cohesively to streamline the entire workflow, from data ingestion and preparation to complex querying and visualization. This integration may ensure that users perform sophisticated data operations, manage large datasets, and generate insightful visualizations directly on their devices (e.g., user device 105). The modular architecture of the JSON data processing platform 103 may allow for scalable and flexible deployment, resulting in adapting to the device's specifications and providing consistent JSON data processing. In one instance, JSON elements may be split into one row per element and may be indented based on their location within the hierarchy, and each element may be represented as a separate line in a structured format. The indentation may reflect the nesting level within the JSON hierarchy, with deeper nested elements indented further to visually indicate their relationship to higher-level elements. This structured representation may facilitate in understanding and visualizing the hierarchical structure of the JSON data.

### Exemplary JSON Array Subscripts Flowchart

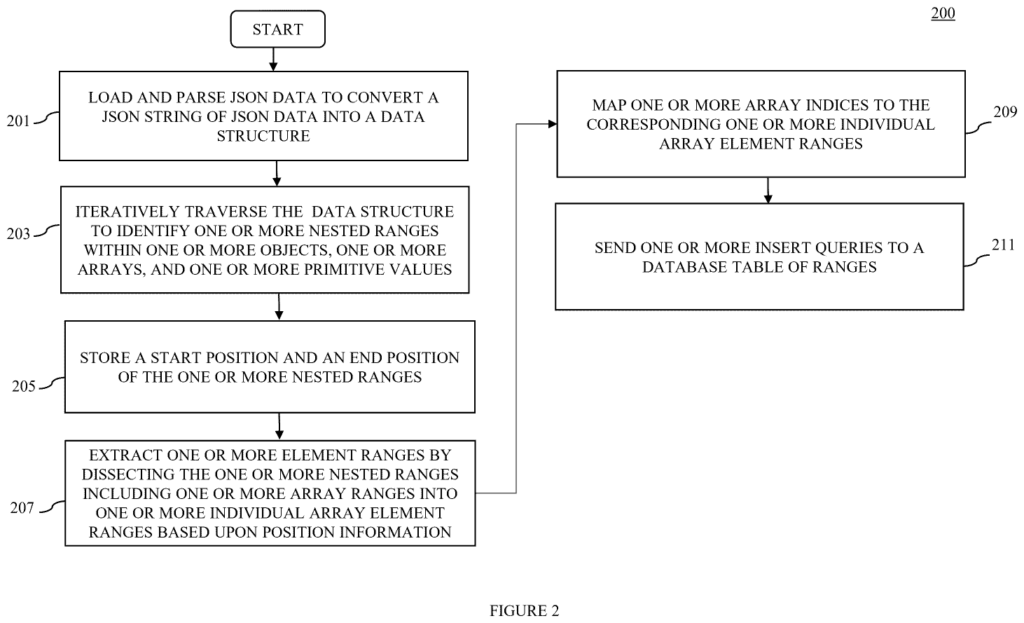

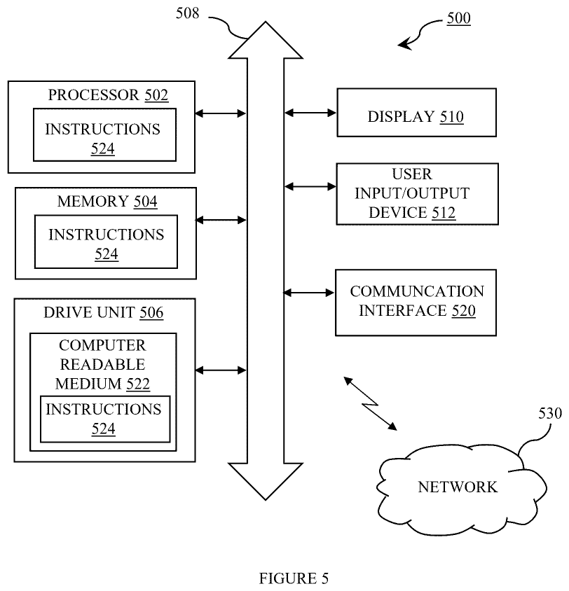

FIG. 2 is an exemplary flowchart of a computer-implemented or computer-based process for deriving array subscripts from nested ranges in a JSON structure. In one instance, the JSON data processing platform 103 and/or any of the modules 107-123 may perform one or more portions of the process 200 and are implemented using, for instance, a chip set including a processor (e.g., processor 502) and a memory (e.g., memory 504) as shown in FIG. 5. As such, the JSON data processing platform 103 and/or any of modules 107-123 may be configured to facilitate accomplishing various parts of the process 200, as well as accomplishing embodiments of other processes described herein in conjunction with other components of the system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the JSON data processing platform 103 may load and parse JSON data to convert a JSON string of the JSON data into a data structure. The JSON data may include one or more objects, one or more arrays, and/or one or more primitive values. In one instance, loading and parsing the JSON data may include reading a JSON string from a file or an API, and determining JSON data is in a valid format by verifying its adherence to the JSON syntax rules and structure. The JSON syntax rules and structures may be defined by a set of conventions that may ensure the data is correctly formatted and can be parsed effectively. For example, JSON objects are enclosed in curly braces ‘{ }’, JSON arrays are enclosed in square brackets ‘[ ]’, strings are enclosed in double quotes, numbers can be integers or floating-point values and are written without quotes, booleans are represented as ‘true’ or ‘false’, and null values are represented as ‘null’. This validation step may confirm that the JSON data is properly formatted, with correct syntax rules for objects, arrays, key-value pairs, and data types. This validation step may check for any errors or inconsistencies that could render the JSON data invalid. In one instance, the JSON data processing platform 103 may convert the JSON data into a usable data structure within a programming environment.

This process may be initiated by ingesting the JSON string, which may contain various elements, such as objects and arrays, and then utilize a JSON parser to decode the JSON string. The parser may interpret the JSON syntax, transforming it into a corresponding data structure. The data structure may typically comprise nested dictionaries and lists in languages like Python, or objects and arrays in languages like JavaScript. This parsed data structure may retain the hierarchical relationships and data types defined in the original JSON, thereby enabling efficient access and manipulation of the embedded objects and arrays for further processing and analysis.

In one example, the method described herein may leverage a PostgreSQL function to transform JSON data into a text format where each key-value pair or element in the JSON may be represented as a separate row in a table. The PostgreSQL function may process the JSON data and may output a text object. This text object may be structured such that each element key from the JSON may be placed on its own row in the table. Each row in the table may be assigned a unique sequential numeric value, and this numeric value may serve as an identifier for each element and may help maintain the order and hierarchy of elements as they appear in the JSON structure.

Nested elements within the JSON may be placed on separate rows in the table, this may ensure that each element, regardless of its level of nesting, is individually represented. Each level of nesting within the JSON structure may be presented by an indentation in the text object. Parent elements may have lower levels of indentation, while child elements may have higher levels of indentation. The method may utilize the indentation level to determine the parent-child relationships between elements. By examining the indentation, it may identify which elements are parents and which are their corresponding child elements at each level of the hierarchy. Based on the parent-child relationships and indentation level, the method may iteratively create nested rages. Each parent element may be assigned a range that may encompass all its child elements. This process may continue until all elements, down to the primitive key-value pairs, are assigned to appropriate ranges. At the final level of the hierarchy, where there are no further child elements, the nested ranges may contain only primitive key-value pairs. These pairs may be the most granular level of data within the JSON structure. By using this method, the hierarchical relationships within the JSON data may be preserved and represented in a structural format that may allow for easy traversal and querying.

In block 203, the JSON data processing platform 103 may iteratively traverse the data structure to identify nested ranges within the one or more objects, the one or more arrays, and one or more primitive values. In one example, the JSON data processing platform 103 may systematically explore the hierarchical data to map out its structure. This process may begin at the root of the data structure and iteratively delve into each nested object, array, and primitive value (e.g., string, numbers, and booleans), and then record the start and end positions, or ranges, of these elements.

By iterating through each level of the hierarchy, the traversal algorithm may create a comprehensive map of the data's structure by pinpointing the exact boundaries of every nested component and primitive values. In one instance, the JSON data processing platform 103 may utilize an iterative function for handling JSON element types that include objects, arrays, and/or primitive values. This iterative approach may facilitate systematic exploration of the JSON data by identifying and processing objects, arrays, and primitive values at every level of nesting. In one example, when the iterative function encounters objects or arrays during traversal, it may perform operations on these elements and may capture metadata such as keys for objects and array indices.

In one example, keys may refer to identifiers for the values in the JSON objects. They are strings that may be used to access the corresponding values in the JSON structure. Each key-value pair in a JSON object may be separated by a colon, with the key on the left and the value on the right (e.g., “name”: “Nick”). The JSON data processing platform 103 may store the metadata for identification of the nested ranges within the JSON data.

In block 205, the JSON data processing platform 103 may store the start position and end position of the one or more nested ranges. In one example, the JSON data processing platform 103 may record the precise location of each element within the hierarchical data structure during traversal. The location recorded during traversal of a hierarchical data structure may be the index or position of each element within arrays or nested arrays, and/or the position of the object or nested objects relative to other objects in the hierarchy. As the traversal algorithm navigates through the data, it may mark the beginning (start position) and the conclusion (end position) of every object, array, and primitive value. These positions may be typically defined in terms of the index within the overall data structure. By capturing these boundaries, the traversal algorithm may create a detailed map of the hierarchical layout, enabling efficient identification and access of specific elements or substructures.

In block 207, the JSON data processing platform 103 may extract one or more element ranges by dissecting the one or more nested ranges that include the one or more array ranges into one or more individual array element ranges based upon position information. In one example, the position information may refer to specific index or location within an array or nested array that may define the placement of an element relative to other elements.

Additionally or alternatively, the JSON data processing platform 103 may systematically break down the hierarchical structure of JSON data to identify the precise boundaries of each array element. This process may include traversing through nested ranges, including arrays nested within objects or other arrays, and determining the start and end positions of each individual array element. By leveraging position information, such as indices, the algorithm may accurately isolate and record the ranges corresponding to each array element's location within the JSON data.

In one instance, the JSON data processing platform 103 may iteratively analyze the elements of the arrays to determine a position range of at least one element. This may include examining the indices of array elements to establish the boundaries of each element's position within the array. In a JSON array containing objects, the boundaries may be the starting index (e.g., the position where an array element begins within the array structure) and the ending index (e.g., the position where an array element concludes relative to the other elements in the array). This analysis may identify the start and end positions of the element, defining its range within the array. The JSON data processing platform 103 may store the position range of the at least one element. The JSON data processing platform 103 may map associated array indices to their corresponding position ranges within the array, establishing a relationship between each array index and its respective position range within the array. By associating each index with its corresponding range, the JSON data processing platform 103 may locate and operate on specific elements within the array.

In block 209, the JSON data processing platform 103 may map one or more array indices (e.g. index positions within the array that may identify the location of each array element) to the corresponding one or more individual array element ranges (e.g., specific positions or ranges that may define the extent of each array element in the array structure) to correlate at least one element of the one or more arrays to the one or more individual array element ranges. In one instance, such correlation may be based upon positional relationship between array indices and the nested ranges that represent specific elements within the array.

In one example, mapping array indices to corresponding individual array elements may include establishing a correlation between the position of elements within the arrays and the specific ranges that encompass them. This process may entail breaking down the overall range of an array into distinct intervals, where each interval represents an individual array element's range. By associating array indices with these element ranges, the system can precisely identify which element corresponds to each range. This correlation may enable efficient navigation and manipulation of array data, as it provides a clear mapping between the array indices and their respective elements within the array.

In one instance, the JSON data processing platform 103 may sort one or more nested ranges hierarchically to reflect a nested structure of the JSON data. In one example, the JSON data processing platform 103 may identify the position ranges of each element, including objects, arrays, and primitive values, and then organize these ranges based upon their levels of nesting.

In various instances, the JSON data processing platform 103 may utilize one or more functions to locate or retrieve at least one element by leveraging the mapped ranges and hierarchical organization of the JSON data. These functions may efficiently navigate the JSON structure using the predefined position and index mappings to pinpoint the exact location of the desired element.

In block 211, the JSON data processing platform 103 may send one or more queries (e.g., insert queries) to a database table of ranges. The queries may include at least one of the one or more array indices and the correlated at least one element. The JSON data processing platform 103 may utilize mapped ranges and metadata associated with the JSON data to identify and extract array indices. These indices may be mapped based upon their position or location in the hierarchical structure.

The JSON data processing platform 103 may identify at least one element based upon the correlation of array indices and element ranges within the JSON data. In one example, the JSON data processing platform 103 may request specific data from the database based upon the provided array indices and the corresponding arrays. These queries may typically specify the desired array indices, along with any associated arrays, as criteria for retrieving relevant information from the database.

In one instance, the JSON data processing platform 103 may validate the extracted element ranges against predefined schema definitions for data consistency and integrity. The JSON data processing platform 103 may check that the ranges and the elements they encompass conform to the expected structure, types, and constraints specified by a schema.

### Exemplary JSON Relational Structure Flowchart

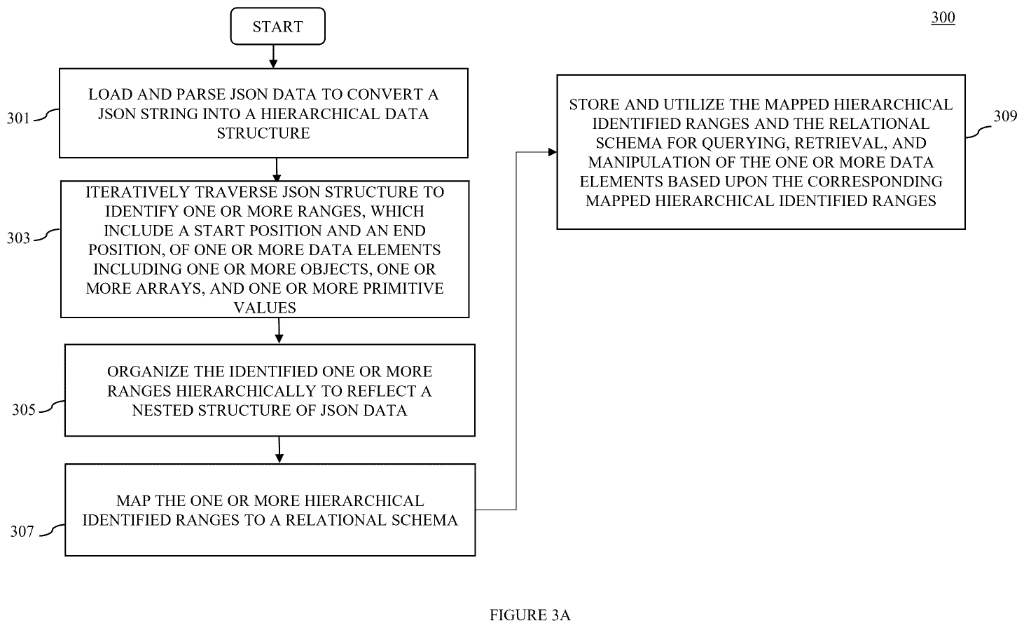

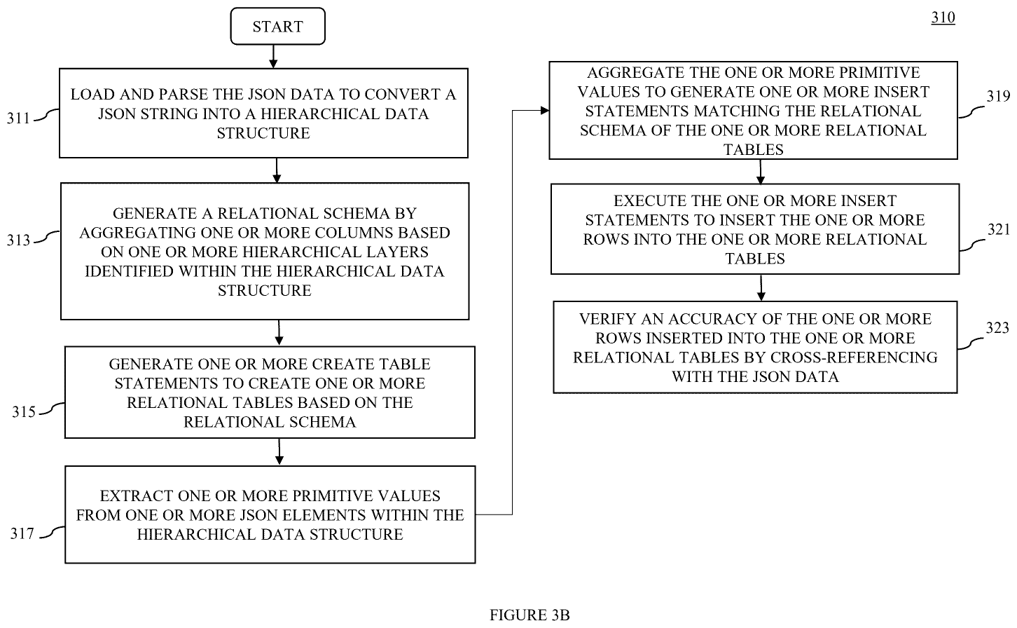

FIG. 3A is an exemplary flowchart of a computer-implemented or computer-based process for generating a relational structure from a JSON data structure. In one instance, the JSON data processing platform 103 and/or any of the modules 107-123 may perform one or more portions of the process 300 and are implemented using, for instance, a chip set including a processor (e.g., processor 502) and a memory (e.g., memory 504) as shown in FIG. 5.

As such, the JSON data processing platform 103 and/or any of modules 107-123 may be configured to facilitate accomplishing various parts of the process 300, as well as accomplishing embodiments of other processes described herein in conjunction with other components of the system 100. Although the process 300 is illustrated and described as a sequence of actions, operations, and/or functionality, it is contemplated that various embodiments of the process 300 may be performed in any order or combination and need not include all of the illustrated actions, operations, and/or functionality.

In block 301, the JSON data processing platform 103 may load and parse JSON data to convert a JSON string into a hierarchical data structure. In one instance, the JSON data may include one or more data elements. In one embodiment, loading and parsing the JSON data may include reading a JSON string from a file or an API, as well as determining that the JSON data is in a valid format by verifying its adherence to the JSON syntax rules and structure. This validation step may confirm that the JSON data is properly formatted according to correct syntax rules for objects, arrays, key-value pairs, and/or data types. This validation step may check for any errors or inconsistencies that could render the JSON data invalid.

In one instance, the JSON data processing platform 103 may convert the JSON data into a usable data structure within a programming environment. This process may start by ingesting the JSON string, which may contain various elements such as objects and arrays, and then utilize a JSON parser to decode the JSON string. The JSON parser may interpret the JSON syntax and transform the JSON syntax into a corresponding data structure. For example, the data structure may typically comprise nested dictionaries and/or lists in languages like Python, or objects and arrays in languages like JavaScript. This parsed data structure may retain the hierarchical relationships and data types defined in the original JSON, thereby enabling efficient access and manipulation of the embedded objects and arrays for further processing and analysis.

In block 303, the JSON data processing platform 103 may iteratively traverse the JSON structure to identify one or more ranges, which include a start position and an end position, of the one or more data elements including one or more objects, one or more arrays, and/or one or more primitive values. In one example, the JSON data processing platform 103 may systematically navigate through the JSON hierarchy to pinpoint the boundaries of each element type and record each element type's position.

In one instance, the JSON data processing platform 103 may utilize an iterative function for handling JSON element types that include objects, arrays, and/or primitive values. This iterative approach may facilitate systematic exploration of the JSON data, identifying and processing objects, arrays, and primitive values at every level of nesting. In one example, when the iterative function encounters objects or arrays during traversal, it may perform operations on these elements and may capture metadata such as keys for objects and array indices. The JSON data processing platform 103 may store the metadata for identification of the nested ranges within the JSON data.

In block 305, the JSON data processing platform 103 may organize the identified one or more ranges hierarchically to reflect the nested structure of the JSON data, while also preserving parent-child relationships between these ranges. In one instance, the JSON data processing platform 103 may structure nested ranges to represent nested relationships between the data elements, wherein the nested relationships may correspond to the nested structure. This may involve arranging the ranges in a layered fashion, where each range may correspond to a nested level within the JSON structure, such as objects within objects or arrays within arrays.

In block 307, the JSON data processing platform 103 may map the one or more hierarchical identified nested ranges to a relational schema. The mapping may define relational tables and corresponding relational table relationships based upon the identified ranges. In one example, the JSON data processing platform 103 may align the nested ranges, which reflect the hierarchical organization of JSON elements and arrays, with corresponding relational schema components. In one instance, the JSON data processing platform 103 may define the relational tables for each type of data element.

In one example, a type of data element may be a “user profile,” and a relational table for a user profile may include elements such as (i) user information table that may store fields like user_id, name, email, and/or (ii) user activity table that may store fields like activity_id, user_id, activity_type, timestamp. These tables may be structured to represent various relationships and attributes associated with user profiles and their activities. One or more tables may include tables for objects, arrays, or primitive values. The JSON data processing platform 103 may create relationships between the tables to reflect the nested structure.

In block 309, the JSON data processing platform 103 may store and utilize the mapped one or more hierarchical identified nested ranges and the relational schema for querying, retrieval, and manipulation of the one or more data elements based upon the corresponding mapped one or more hierarchical identified nested ranges. By referencing the mapped hierarchical ranges, the JSON data processing platform 103 may precisely identify and operate on specific data elements, ensuring accurate data retrieval and manipulation. In one instance, the JSON data processing platform 103 may utilize functions to query and retrieve the data elements based upon the ranges and the mapping of the hierarchical identified nested ranges to the relational schema.

In one instance, the JSON data processing platform 103 may dynamically update the ranges and the mapping of the hierarchical identified nested ranges to the relational schema based upon modification to the JSON data. This method may enable the relational structure to adapt seamlessly to changes in the underlying JSON structure, ensuring that the relational schema remains accurate and up-to-date.

### Exemplary Automated JSON to Relational Table Flowchart

FIG. 3B is an exemplary flowchart of a computer-implemented or computer-based process for generating create table statements and/or insert statements to automate the conversion of JSON data to relational tables. In one instance, the JSON data processing platform 103 and/or any of the modules 107-123 may perform one or more portions of the process 310 and are implemented using, for instance, a chip set including a processor (e.g., processor 502) and a memory (e.g., memory 504) as shown in FIG. 5.

As such, the JSON data processing platform 103 and/or any of modules 107-123 may be configured to facilitate accomplishing various parts of the process 310, as well as accomplishing embodiments of other processes described herein in conjunction with other components of the system 100. Although the process 310 is illustrated and described as a sequence of actions, operations, and/or functionality, it is contemplated that various embodiments of the process 310 may be performed in any order or combination and need not include all of the illustrated actions, operations, and/or functionality.

In block 311, the JSON data processing platform 103 may load and parse JSON data to convert a JSON string into a hierarchical data structure. The JSON data may include one or more data elements. The hierarchical data structure may include one or more nested arrays and one or more nested objects. In one embodiment, loading and parsing the JSON data may include reading a JSON string from a file or an API, and employing a JSON parsing tool to interpret its syntax and structure. The JSON parsing tool may convert the JSON string into a structural format, identifying and categorizing its components, such as objects, arrays, and primitive key-value pairs. The JSON parsing tool may analyze each data element to determine its role and position within the hierarchy, enabling the construction of a detailed data structure that mirrors the JSON data's nested relationships and attributes.

In block 313, the JSON data processing platform 103 may generate a relational schema by aggregating one or more columns based on the hierarchical layer(s) identified within the hierarchical data structure. The relational schema may define one or more columns and one or more relationships to represent the one or more nested arrays and the one or more nested objects. The JSON data processing platform 103 may analyze the hierarchical relationships between various data elements, such as objects, arrays, and primitive key-value pairs, as parsed from the JSON data. The JSON data processing platform 103 may examine each hierarchical layer to determine the relevant columns needed for the relational schema. Columns may be aggregated based on their hierarchical context, ensuring that each layer's structure is accurately represented in the schema. This schema facilitates the creation of relational tables, and may define how data is organized and related across different levels of the hierarchy.

In block 315, the JSON data processing platform 103 may generate one or more create table statements (e.g., SQL create table statements) for creating one or more relational table(s) based on the relational schema. In one instance, each SQL create table statement may specify table name, column name, data type, and constraints that reflect the various data types and structures extracted from the JSON data. In one instance, if the JSON data includes a hierarchical structure with nested objects and arrays, the SQL create table statements may be fabricated to accommodate these elements by defining columns that map to the JSON attributes. For example, if JSON data includes user information with fields for ‘User ID’, ‘Username’, and ‘Email’, the JSON data processing platform 103 may fabricate the SQL create table statement, such as:

CREATE TABLE Users (
UserID INT PRIMARY KEY,
Username VARCHAR (50),
Email VARCHAR (100)
)

In this example, the SQL create table statement is created with three columns: ‘UserID’ (an integer that servers as the primary key), ‘Username’ (a variable character field with a maximum length of 50 characters), and ‘Email’ (a variable character field with a maximum length of 100 characters). This table structure may ensure that the data types and constraints defined in the schema are properly implemented, facilitating the accurate storage and organization of the data extracted from JSON elements. This example illustrates one possible table configuration, and various other variations of the table can be fabricated depending on the specifics of the data types and structures present in the JSON data.

In one instance, the relational schema of the relational table(s) may accommodate one or more data types and one or more structures derived from the JSON data. In one instance, the JSON data processing platform 103 may implement a mapping mechanism to translate the one or more columns identified in the schema into one or more relational attributes, ensuring that each column in the relational table(s) accurately reflects the corresponding hierarchical layer of the JSON data. In one instance, the relational table(s) may be designed according to the relational schema to accurately reflect the data types and structures identified in the JSON data. This process may include defining the relational table's schema, such as specifying column names, data types, and constraints, to accommodate the diverse range of data elements, including objects, arrays, and primitive key-value pairs. The relational schema may ensure that each relational table is configured to store and organize data in a manner that preserves its hierarchical relationships and integrity. By aligning the table structure with the JSON data's hierarchical layers, the fabricated relational tables facilitate effective data management and retrieval.

In block 317, the JSON data processing platform 103 may extract one or more primitive values from JSON element(s) within the hierarchical data structure. In one instance, extracting primitive value(s) may involve identifying and retrieving fundamental data components, such as strings, numbers, or Booleans, within the hierarchical data structure. The JSON data processing platform 103 may access these values from various levels of the JSON hierarchy, including nested objects and arrays.

In block 319, once extracted, the JSON data processing platform 103 may organize and aggregate these primitive values to generate one or insert statements (e.g., SQL insert statements) matching the relational schema of the one or more relational tables. In one example, the JSON data processing platform 103 may collect the fundamental data points from the JSON data and organize them into a format suitable for the SQL insert statements, which are then used to populate the relational tables. Each insert statement is an SQL command that adds one or more rows of data into a relational table, with each row corresponding to a specific record. For example, a relational table may be designed to store user information with columns for ‘User ID’, ‘Username’, and ‘Email’. The JSON data processing platform 103 may fabricate the SQL insert statement, such as:

INSERT INTO Users (UserID, Username, Email)
VALUES (1, ‘psmith’, ‘psmith@exampe.com’);

In this example SQL insert statement, ‘Users’ is the name of the table, and ‘User ID’, ‘Username’, and ‘Email’ are the columns into which respective values (1, ‘psmith’, ‘psmith@exampe.com’) are inserted. This process may ensure that the data extracted from the JSON elements is accurately mapped to the relational schema, facilitating effective storage and retrieval within the database. This example shows one possible insert statement, and various other statements may be generated depending on the specific rows and values extracted from the JSON elements.

In block 321, the JSON data processing platform 103 may execute the one or more insert statements to insert the rows into the relational table(s). The JSON data processing platform 103 may ensure that each row is accurately placed into the appropriate table, with all data fields correctly mapped to the corresponding columns. The JSON data processing platform 103 may maintain data integrity and consistency by validating that the values conform to the expected data types and constraints defined in the schema. The JSON data processing platform 103 may check for and address any discrepancies or anomalies that may arise during the insertion process, such as duplicate entries, null values, or data type mismatches. The JSON data processing platform 103 may ensure that the final database reflects an accurate, complete, and reliable representation of the original JSON data, preserving the relational and hierarchies inherent in the data.

In block 323, the JSON data processing platform 103 may verify the accuracy of one or more rows inserted into one or more relational tables by cross-referencing the one or more rows with the JSON data. In one embodiment, the JSON data processing platform 103 may generate a report indicating discrepancies between row(s) inserted into the relational table(s) and the original JSON data. The discrepancies may include data misalignments or erroneous rows. The JSON data processing platform 103 may update the row(s) to correct the discrepancies to ensure the accuracy of the information in the relational table.

In such a manner, the JSON data processing platform 103 may seamlessly translate complex, hierarchical JSON data into a structured relational format, facilitating efficient data management, querying, and analysis. Such automation of the conversion process may eliminate manual effort required to map JSON structures to relational tables, reducing errors and inconsistencies. Such conversion to relational tables may enable the use of established database functionalities, such as indexing and optimized query processing, to handle large volumes of JSON data effectively. The JSON data processing platform 103 may also preserve the hierarchical relationships within the data, ensuring that complex data structures are accurately represented and easily accessible in a relational database, thereby improving the efficiency of data retrieval, analysis, and reporting.

### Exemplary JSON Data Extraction Flowchart

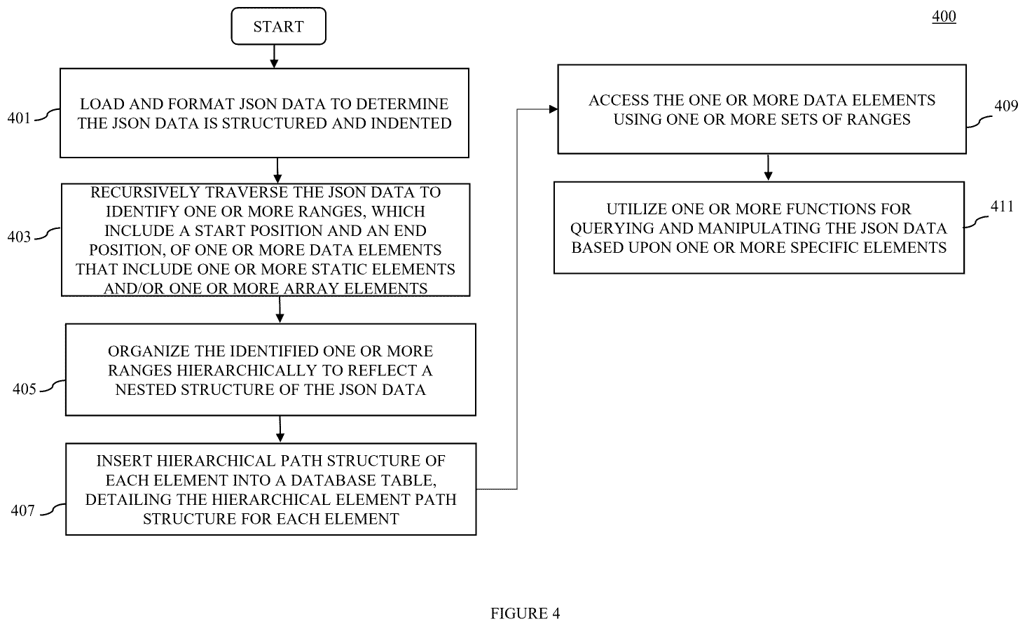

FIG. 4 is an exemplary flowchart of a computer-implemented or computer-based process for extracting data from a JSON structure using a range of rows. In one instance, the JSON data processing platform 103 and/or any of the modules 107-123 may perform one or more portions of the process 400 and are implemented using, for instance, a chip set including a processor (e.g., processor 502) and a memory (e.g., memory 504) as shown in FIG. 5. As such, the JSON data processing platform 103 and/or any of modules 107-123 may be configured to facilitate accomplishing various parts of the process 400, as well as accomplishing embodiments of other processes described herein in conjunction with other components of the system 100. Although the process 400 is illustrated and described as a sequence of actions, operations, and/or functionality, it is contemplated that various embodiments of the process 400 may be performed in any order or combination and need not include all of the illustrated actions, operations, and/or functionality.

In block 401, the JSON data processing platform 103 may load and format JSON data to determine that the JSON data is structured and indented. In one instance, the JSON data may include one or more data elements. In one instance, loading and parsing the JSON data may include reading a JSON string from a file or an API, and determining that the JSON data is in a valid format by verifying its adherence to the JSON syntax rules and structure. This validation step may confirm that the JSON data is properly formatted, with correct syntax rules for objects, arrays, key-value pairs, and data types. This validation step may check for any errors or inconsistencies that could render the JSON data invalid. In one example, a Postgres SQL JSON function may be utilized to format and indent the JSON data, which may facilitate organizing the JSON data into a readable and consistent structure. By leveraging PostgreSQL's built-in JSON formatting capabilities, the data may be automatically arranged with appropriate indentation and structure, facilitating easier analysis and validation of the JSON data. For example, PostgreSQL provides functions like “jsonb_pretty” that may take a JSONB (binary JSON) input and may return a formatted, indented string version of the JSON data.

In block 403, the JSON data processing platform 103 may recursively traverse the JSON data to identify ranges. The ranges may include a start position and an end position of data elements. The ranges may include one or more static elements and/or one or more array elements. In one instance, the JSON data processing platform 103 may identify the static elements that include strings, numbers, booleans, or null values. The JSON data processing platform 103 may record a start position and an end position of the static elements. In one instance, the JSON data processing platform 103 may identify the array elements including objects, nested arrays, or primitive values. The JSON data processing platform 103 may record a start position and an end position of each of the array elements.

In block 405, the JSON data processing platform 103 may organize the identified ranges hierarchically to reflect a nested structure of the JSON data in a single row. In one example, the JSON data processing platform 103 may arrange the start and end positions of each identified elements, including the static and array elements, in a way that mirrors the inherent nested nature of the JSON format. By establishing a hierarchical order, the JSON data processing platform 103 may ensure that parent-child relationships among elements are maintained.

In block 407, the JSON data processing platform 103 may generate a database table to organize and store all elements within a JSON structure based on their hierarchical paths. The process may involve selecting a distinct row for every hierarchical path and element combination from a large dataset of JSON files that have been processed to map hierarchical paths to elements. The JSON data may be processed to extract and record these paths, breaking down the data into its component elements and their respective positions within the hierarchy. The table may consolidate all unique hierarchical paths and their corresponding elements, facilitating efficient querying and analysis. For example, if a JSON structure has multiple nested arrays and objects, the table may capture each element's path from the root to its specific location within the structure. Organizing data in this manner may facilitate quick access and analysis of the structure and key-value pairs of the JSON data, thereby enhancing the ability to understand and manipulate complex datasets.

In block 409, the JSON data processing platform 103 may access the elements using one or more sets of ranges. The accessing may include locating and extracting specific elements within the JSON data. In one instance, the JSON data processing platform 103 may utilize one or more algorithms to navigate the nested structure based upon the ranges to extract the specific elements. In one example, the specific elements may refer to individual components or data points within the JSON structure, such as objects, arrays, or primitive values. These elements may be identified based upon their defined ranges, which may specify the start position and the end position of each entity within the JSON data. By using these ranges, the process may facilitate efficient targeting and extraction of the desired elements.

In block 411, the JSON data processing platform 103 may utilize functions for querying and manipulating the JSON data based upon specific elements. In one instance, the JSON data processing platform 103 may develop query functions that utilize the sets of ranges to retrieve the elements based upon positions within the JSON data.

### Exemplary Computing Environment

In general, any process or operation discussed in this disclosure is understood to be computer-implementable, such as the processes illustrated in FIGS. 2, 3, and 4 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 5 illustrates an implementation of a computer system that may execute techniques presented herein. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 500 may be implemented using electronic devices that provide voice, video, or data communication. Further, while the computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 may include a cache or random-access memory for the processor 502. In alternative implementations, the memory 504 is separate from the processor 502, such as a cache memory of a processor, the system memory, or other memory.

The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of the computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g., software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, computer-readable medium 522 includes the set of instructions 524 or receives and executes the set of instructions 524 responsive to a propagated signal so that a device connected to network 530 can communicate voice, video, audio, images, or any other data over the network 530. Further, the set of instructions 524 may be transmitted or received over the network 530 via communication port or interface 520, and/or using bus 508. The communication port or interface 520 may be a part of the processor 502 or may be a separate component. The communication port or interface 520 may be created in software or may be a physical connection in hardware.

The communication port or interface 520 may be configured to connect with a network 530, external media, the display 510, or any other components in computer system 500, or combinations thereof. The connection with the network 530 may be a physical connection, such as a wired Ethernet connection or may be established wirelessly as discussed below. Likewise, the additional connections with other components of the computer system 500 may be physical connections or may be established wirelessly. The network 530 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 500 may be connected to network 530. The network 530 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 530 may include wide area networks (WAN), such as the Internet, local area networks (LAN), campus area networks, metropolitan area networks, a direct connection such as through a Universal Serial Bus (USB) port, or any other networks that may allow for data communication.

The network 530 may be configured to couple one computing device to another computing device to enable communication of data between the devices. The network 530 may generally be enabled to employ any form of machine-readable media for communicating information from one device to another. The network 530 may include communication methods by which information may travel between computing devices.

The network 530 may be divided into sub-networks. The sub-networks may allow access to all of the other components connected thereto or the sub-networks may restrict access between the components. The network 530 may be regarded as a public or private network connection and may include, for example, a virtual private network or an encryption or other security mechanism employed over the public Internet, or the like.

### Exemplary Embodiment

A computer-implemented method for deriving array subscripts from nested ranges in a JSON structure may be provided. The computer-implemented method may be performed by one or more local or remote processors of a computing system in communication with one or more local or remote data sources. The computer-implemented method may include (1) loading and parsing JSON data to convert a JSON string of the JSON data into a data structure, wherein the JSON data includes one or more objects, one or more arrays, and/or one or more primitive values; (2) traversing the data structure to identify one or more nested ranges within the one or more objects, the one or more arrays, and/or the one or more primitive values; (3) storing a start position and an end position of the one or more nested ranges; (4) extracting one or more element ranges by dissecting the one or more nested ranges, including one or more array ranges, into one or more individual array element ranges based upon position information; (5) mapping one or more array indices to the corresponding one or more individual array element ranges, wherein the mapping includes correlating at least one element of the one or more arrays to the one or more individual array element ranges; and/or (6) sending one or more queries to a database, wherein the one or more queries include at least one of the one or more array indices and the correlated at least one element.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

For instance, loading and parsing the JSON data may include (i) reading the JSON data from a file or an application programming interface (API); and (ii) determining that the JSON data is in a valid format by performing a validation check to assess adherence to JSON syntax.

In certain aspects, traversing the data structure may include (i) utilizing a recursive function for handling one or more JSON element types that include one or more of the one or more objects, the one or more arrays, or the one or more primitive values; and (ii) storing metadata for identification of the one or more nested ranges within the JSON data, wherein the metadata includes one or more keys for the one or more objects and the one or more array indices.

In certain embodiments, extracting the one or more element ranges may include (i) analyzing the at least one element of the one or more arrays to determine a position range of the at least one element; (ii) storing the position range of the at least one element; and (iii) mapping associated array indices to corresponding position ranges within the one or more arrays.

For instance, mapping the one or more array indices to the corresponding one or more individual array element ranges may include sorting the one or more nested ranges hierarchically to reflect a nest structure of the JSON data.

In certain aspects, utilizing the mapped array indices to the corresponding one or more individual array element ranges may include utilizing one or more functions to locate or retrieve the at least one element.

Additionally or alternatively, deriving array subscripts from nested ranges in a JSON structure may validating the extracted element ranges against predefined schema.

A computer-implemented method for generating a relational structure from a JSON data structure may be provided. The computer-implemented method may be performed by one or more local or remote processors of a computing system in communication with one or more local or remote data sources. The computer-implemented method may include (1) loading and parsing JSON data to convert a JSON string into a hierarchical data structure, wherein the JSON data includes one or more data elements; (2) traversing the JSON structure to identify one or more ranges, which include a start position and an end position, of the one or more data elements including one or more objects, one or more arrays, and one or more primitive values; (3) organizing the identified one or more ranges hierarchically to reflect a nested structure of the JSON data; (4) mapping the one or more hierarchical identified nested ranges to a relational schema, wherein the mapping includes defining one or more relational tables and one or more corresponding relational table relationships based upon the identified ranges; and/or (5) storing and utilizing the mapped hierarchical identified nested ranges and the relational schema for querying, retrieval, and manipulation of the one or more data elements based upon the corresponding mapped hierarchical identified nested ranges.

For instance, loading and parsing the JSON data may include (i) reading the JSON data from a file or an application programming interface (API); and/or (ii) determining that the JSON data is in a valid format by performing a validation check to assess adherence to JSON syntax.

In certain aspects, traversing the JSON structure may include (i) utilizing a recursive function for handling one or more JSON element types including the one or more of the objects, the one or more arrays, or the one or more primitive values; and/or (ii) storing metadata including one or more keys for the one or more objects and one or more array indices for identification of the one or more nested ranges within the JSON data.

In certain embodiment, organizing the one or more identified ranges hierarchically may include structuring nested ranges to represent one or more nested relationships between the one or more data elements, wherein the one or more nested relationships correspond to the nested structure.

For instance, mapping the one or more hierarchical identified nested ranges to the relational schema may include (i) defining the one or more relational tables for each type of the one or more data elements, wherein the one or more tables include one or more tables for the one or more objects, the one or more arrays, or the one or more primitive values; and/or (ii) creating one or more relationships between the one or more tables to reflect the nested structure.

In certain aspects, storing and utilizing the mapped hierarchical identified nested ranges and the relational schema may include utilizing one or more functions to query and retrieve the one or more data elements based upon the one or more ranges and the mapping of the one or more hierarchical identified nested ranges to the relational schema.

Additionally or alternatively, generating a relational structure from a JSON data structure may include dynamically updating the one or more ranges and the mapping of the one or more hierarchical identified nested ranges to the relational schema based upon modification to the JSON data.

A computer-implemented method for automating a conversion of JSON data to one or more relational tables may be provided. The computer-implemented method may be performed by one or more local or remote processors of a computing system in communication with one or more local or remote data sources. The computer-implemented method may include (1) loading and parsing the JSON data to convert a JSON string into a hierarchical data structure, wherein the JSON data includes one or more data elements; (2) generating a relational schema by aggregating one or more columns based on one or more hierarchical layers identified within the hierarchical data structure; (3) generating one or more create table statements for creating the one or more relational tables based on the relational schema, wherein the relational schema of each of the one or more relational tables includes one or more data types and one or more structures derived from the JSON data; (4) extracting one or more primitive values from one or more JSON elements within the hierarchical data structure; (5) aggregating the one or more primitive values to generate one or more insert statements matching the relational schema of the one or more relational table; (6) executing the one or more insert statements to insert one or more rows into the one or more relational tables; and/or (6) verifying an accuracy of the one or more rows inserted into the one or more relational tables by cross-referencing the one or more rows with the JSON data.

In certain aspects, the hierarchical data structure may include one or more nested arrays and one or more nested objects. The relational schema may define one or more columns and one or more relationships to represent the one or more nested arrays and the one or more nested objects.

In certain embodiments, generating one or more create table statements for creating the one or more relational tables may include (i) implementing a mapping mechanism for translating the one or more columns into one or more relational attributes; and (ii) populating the one or more relational tables with data extracted from the one or more JSON elements.

In certain embodiments, verifying the accuracy of the one or more rows may include (i) generating a report indicating one or more discrepancies between the one or more rows inserted into the one or more relational tables and the JSON data, wherein the one or more discrepancies include one or more data misalignments or one or more erroneous rows; and (ii) updating the one or more rows to correct the one or more discrepancies.

A computer-implemented method for extracting data from a JSON structure using range of rows may be provided. The computer-implemented method may be performed by one or more local or remote processors of a computing system in communication with one or more local or remote data sources. The computer-implemented method may include (1) loading and formatting JSON data to determine the JSON data is structured and indented, wherein the JSON data includes one or more data elements; (2) traversing the JSON data to identify one or more ranges, which include a start position and an end position, of the one or more data elements that include one or more static elements and/or one or more array elements; (3) organizing the identified one or more ranges hierarchically to reflect a nested structure of the JSON data; (4) accessing the one or more data elements using one or more sets of ranges, wherein the accessing includes locating and extracting one or more specific elements within the JSON data; and/or (5) utilizing one or more functions for querying and manipulating the JSON data based upon the one or more specific elements.

For instance, loading and formatting the JSON data may include (i) reading the JSON data from a file or an application programming interface (API); and/or (ii) determining that the JSON data is in a valid format by performing a validation check to assess adherence to JSON syntax.

In certain aspects, traversing the JSON data may include (i) identifying the one or more static elements including one or more of one or more strings, one or more numbers, one or more booleans, or one or more null values; and/or (ii) recording a start position and an end position of the one or more static elements.

In certain embodiment, traversing the JSON data may include (i) identifying the one or more array elements, wherein the array elements include one or more objects, one or more nested arrays, or one or more primitive values; and/or (ii) recording a start position and an end position of each of the one or more array elements.

For instance, organizing the identified sets of ranges hierarchically may include utilizing one or more data structures that include one or more lists or one or more dictionaries to maintain the organized sets of ranges hierarchically.

In certain aspects, accessing the one or more elements using the sets of ranges may include utilizing one or more algorithms to navigate the nested structure based upon the one or more ranges to extract the one or more specific elements.

In certain embodiments, utilizing the one or more functions for querying and manipulating may include developing one or more query functions that utilize the sets of ranges to retrieve the one or more elements based upon one or more positions within the JSON data.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In various embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

1. A computer-implemented method for deriving array subscripts from nested ranges in a JSON structure, comprising:
loading and parsing JSON data to convert a JSON string of the JSON data into a data structure, wherein the JSON data includes one or more objects, one or more arrays, and/or one or more primitive values;
standardizing the JSON data by normalizing one or more JSON keys corresponding to the JSON data, handling one or more missing or null values of the JSON data, detecting and correcting a duplicated entry and a format discrepancy of the JSON data, or converting one or more data types of the JSON data;
traversing the data structure to identify one or more nested ranges within the one or more objects, the one or more arrays, and/or the one or more primitive values;
storing a start position and an end position of the one or more nested ranges;
extracting one or more element ranges by dissecting the one or more nested ranges, including one or more array ranges, into one or more individual array element ranges based upon position information, wherein the position information indicates a specific index or location within the one or more arrays that defines an element placement of at least one element relative to one or more other elements;
mapping one or more array indices to the corresponding one or more individual array element ranges, wherein the mapping includes correlating at least one array element of the one or more arrays to the one or more individual array element ranges;
indexing the JSON data into one or more addressable segments, each segment of the one or more addressable segments corresponding to a portion of the JSON structure defined by the one or more nested ranges; and
sending one or more queries to a database, wherein the one or more queries include at least one of the one or more array indices and the correlated at least one array element.

2. The computer-implemented method of claim 1, wherein loading and parsing the JSON data comprises:
reading the JSON data from a file or an application programming interface (API); and
determining that the JSON data is in a valid format by performing a validation check to assess adherence to JSON syntax.

3. The computer-implemented method of claim 1, wherein traversing the data structure comprises:
utilizing a recursive function for handling one or more JSON element types that include one or more of the one or more objects, the one or more arrays, or the one or more primitive values; and
storing metadata for identification of the one or more nested ranges within the JSON data, wherein the metadata includes one or more keys for the one or more objects and the one or more array indices.

4. The computer-implemented method of claim 1, wherein extracting the one or more element ranges comprises:
analyzing the at least one element of the one or more arrays to determine a position range of the at least one element;
storing the position range of the at least one element; and
mapping associated array indices to corresponding position ranges within the one or more arrays.

5. The computer-implemented method of claim 1, wherein mapping the one or more array indices to the corresponding one or more individual array element ranges comprises:
sorting the one or more nested ranges hierarchically to reflect a nest structure of the JSON data.

6. The computer-implemented method of claim 1, wherein utilizing the mapped one or more array indices to the corresponding one or more individual array element ranges comprises:
utilizing one or more functions to locate or retrieve the at least one element.

7. The computer-implemented method of claim 1, further comprising:
validating the extracted element ranges against predefined schema.

8. A computer-implemented method for generating a relational structure from a JSON data structure, comprising:
loading and parsing JSON data to convert a JSON string into a hierarchical data structure, wherein the JSON data includes one or more data elements;
traversing the JSON data structure to identify one or more ranges, which include a start position and an end position, of the one or more data elements including one or more objects, one or more arrays, and one or more primitive values;
standardizing the JSON data by normalizing one or more JSON keys, handling missing or null values, detecting the JSON data by normalizing one or more JSON keys corresponding to the JSON data, handling one or more missing or null values of the JSON data, detecting and correcting a duplicated entry and a format discrepancy of the JSON data, or converting one or more data types of the JSON data;
organizing the identified one or more ranges hierarchically to reflect a nested structure of the JSON data, wherein the organizing includes preserving at least one parent-child relationship between the one or more ranges;
mapping the one or more hierarchical identified nested ranges to a relational schema, wherein the mapping includes defining one or more relational tables and one or more corresponding relational table relationships based upon the identified ranges;
dynamically adjusting the mapping within the one or more relational tables and the one or more corresponding relational table relationships based upon relational database principles; and
storing and utilizing the mapped one or more hierarchical identified nested ranges and the relational schema for querying, retrieval, and manipulation of the one or more data elements based upon the corresponding mapped one or more hierarchical identified nested ranges.

9. The computer-implemented method of claim 8, wherein loading and parsing the JSON data comprises:
reading the JSON data from a file or an application programming interface (API); and
determining that the JSON data is in a valid format by performing a validation check to assess adherence to JSON syntax.

10. The computer-implemented method of claim 8, wherein traversing the JSON structure comprises:
utilizing a recursive function for handling one or more JSON element types including the one or more of the objects, the one or more arrays, or the one or more primitive values; and
storing metadata including one or more keys for the one or more objects and one or more array indices for identification of the one or more nested ranges within the JSON data.

11. The computer-implemented method of claim 8, wherein organizing the one or more identified ranges hierarchically comprises:
structuring nested ranges to represent one or more nested relationships between the one or more data elements, wherein the one or more nested relationships correspond to the nested structure.

12. The computer-implemented method of claim 8, wherein mapping the one or more hierarchical identified nested ranges to the relational schema comprises:
defining the one or more relational tables for each type of the one or more data elements, wherein the one or more tables include one or more tables for the one or more objects, the one or more arrays, or the one or more primitive values; and
creating one or more relationships between the one or more tables to reflect the nested structure.

13. The computer-implemented method of claim 8, wherein storing and utilizing the mapped one or more hierarchical identified nested ranges and the relational schema comprises:
utilizing one or more functions to query and retrieve the one or more data elements based upon the one or more ranges and the mapping of the one or more hierarchical identified nested ranges to the relational schema.

14. The computer-implemented method of claim 13, further comprising:
dynamically updating the one or more ranges and the mapping of the one or more hierarchical identified nested ranges to the relational schema based upon modification to the JSON data.

15. A computer-implemented method for extracting data from a JSON structure using range of rows, comprising:
loading and formatting JSON data to determine the JSON data is structured and indented, wherein the JSON data includes one or more data elements;
standardizing the JSON data by normalizing one or more JSON keys corresponding to the JSON data, handling one or more missing or null values of the JSON data, detecting and correcting a duplicated entry and a format discrepancy of the JSON data, or converting one or more data types of the JSON data;
traversing the JSON data to identify one or more ranges, which include a start position and an end position, of the one or more data elements that include one or more static elements and/or one or more array elements;
organizing the identified one or more ranges hierarchically to reflect a nested structure of the JSON data, wherein the organizing includes arranging the start position and the end position of the one or more ranges to mirror an inherent nested nature of a JSON format;
accessing the one or more data elements using one or more sets of ranges, wherein the accessing includes locating and extracting one or more specific elements within the JSON data;
indexing the JSON data into one or more addressable segments, each segment of the one or more addressable segments corresponding to a portion of the JSON structure defined by the one or more hierarchically organized ranges; and
utilizing one or more functions for querying and manipulating the JSON data based upon the one or more specific elements.

16. The computer-implemented method of claim 15, wherein loading and formatting the JSON data comprises:
reading the JSON data from a file or an application programming interface (API); and
determining that the JSON data is in a valid format by performing a validation check to assess adherence to JSON syntax.

17. The computer-implemented method of claim 15, wherein traversing the JSON data comprises:
identifying the one or more static elements including one or more of one or more strings, one or more numbers, one or more booleans, or one or more null values; and
recording a start position and an end position of the one or more static elements.

18. The computer-implemented method of claim 15, wherein traversing the JSON data comprises:
identifying the one or more array elements, wherein the array elements include one or more objects, one or more nested arrays, or one or more primitive values; and
recording a start position and an end position of each of the one or more array elements.

19. The computer-implemented method of claim 15, wherein organizing the identified sets of ranges hierarchically comprises:
utilizing one or more data structures that include one or more lists or one or more dictionaries to maintain the organized sets of ranges hierarchically.

20. The computer-implemented method of claim 15, wherein accessing the one or more elements using the sets of ranges comprises:
utilizing one or more algorithms to navigate the nested structure based upon the one or more ranges to extract the one or more specific elements.

21. A computer-implemented method for automating a conversion of JSON data to one or more relational tables, comprising:
loading and parsing the JSON data to convert a JSON string into a hierarchical data structure, wherein the JSON data includes one or more data elements;
standardizing the JSON data by normalizing one or more JSON keys corresponding to the JSON data, handling one or more missing or null values of the JSON data, detecting and correcting a duplicated entry and a format discrepancy of the JSON data, or converting one or more data types of the JSON data;
organizing the hierarchical data structure by identifying one or more hierarchical boundaries within the JSON data, assigning one or more ranges to the one or more data elements, or establishing one or more parent-child relationships within the JSON data;
generating a relational schema by aggregating one or more columns based on one or more hierarchical layers identified within the hierarchical data structure;
generating one or more create table statements for creating the one or more relational tables based on the relational schema, wherein the relational schema of each of the one or more relational tables includes one or more data types and one or more structures derived from the JSON data, wherein the one or more columns of the relational schema are translated into one or more relational attributes that correspond to one or more respective hierarchical layers of the JSON data;
extracting one or more primitive values from one or more JSON elements within the hierarchical data structure;
aggregating the one or more primitive values to generate one or more insert statements matching the relational schema of the one or more relational tables;
executing the one or more insert statements to insert one or more rows into the one or more relational tables; and
verifying an accuracy of the one or more rows inserted into the one or more relational tables by cross-referencing the one or more rows with the JSON data.

22. The computer-implemented method of claim 21, wherein the hierarchical data structure includes one or more nested arrays and one or more nested objects, and wherein the relational schema defines the one or more columns and one or more relationships to represent the one or more nested arrays and the one or more nested objects.

23. The computer-implemented method of claim 21, wherein generating the one or more create table statements for creating the one or more relational tables comprises:
implementing a mapping mechanism for translating the one or more columns into the one or more relational attributes; and
populating the one or more relational tables with data extracted from the one or more JSON elements based on the one or more relational attributes.

24. The computer-implemented method of claim 21, wherein verifying the accuracy of the one or more rows comprises:
generating a report indicating one or more discrepancies between the one or more rows inserted into the one or more relational tables and the JSON data, wherein the one or more discrepancies include one or more data misalignments or one or more erroneous rows; and
updating the one or more rows to correct the one or more discrepancies.
